(19) United States
(12) Patent Application Publication
(10) Pub. No.: US 2014/0290925 A1
(43) Pub. Date: Oct. 2, 2014

(54) FLOW DIVERTERS TO ENHANCE HEAT SINK PERFORMANCE

(71) Applicant: Alcatel-Lucent USA Inc., Murray Hill, NJ (US)

(72) Inventors: Domhnaill Hernon, Bettystown (IE); Marc Hodes, Dublin (IE); Alan Lyons, New Providence, NJ (US); Alan O'Loughlin, Dublin (IE); Shankar Krishnan, Richland, WA (US)

(73) Assignee: Alcatel-Lucent USA Inc., Murray Hill, NJ (US)

(21) Appl. No.: 14/228,124

(22) Filed: Mar. 27, 2014

Related U.S. Application Data
(63) Continuation of application No. 12/165,193, filed on Jun. 30, 2008.

(51) Int. Cl. F28F 3/02; B23P 15/26

(52) U.S. Cl. CPC F28F 3/02; B23P 15/26
USPC 165/185; 29/890.03

(57) ABSTRACT

A heat sink comprising a base, fins attached to the base and a flow diverter in contact with the base or at least one of the fins. The flow diverter has a rectangular cross-sectional profile in a plane that is coplanar with and elevated above a plane of the base and spanning the entire separation distance, and, a segment of the flow diverter is angled towards the base to direct the fluid flow towards the base.

### CROSS-REFERENCE TO RELATED APPLICATION

The present application is a continuation application of U.S. patent application Ser. No. 12/165,193 to Hernon et al., entitled “FLOW DIVERTERS TO ENHANCE HEAT SINK PERFORMANCE”, filed on Jun. 30, 2008, and which is commonly assigned with the present application, and incorporated by reference herein in its entirity.

### TECHNICAL FIELD

The present invention is directed, in general, to heat sinks.

### BACKGROUND

Heat sinks are commonly used to increase the convective surface area of an electronic device to decrease the thermal resistance between the device and cooling medium, e.g., air. Such heat sinks generally employ fins or pins to exchange heat with a fluid (air or liquid) flowing thereover. Some electronic components dissipate enough power that air-cooled heat sinks are becoming inadequate to sufficiently cool these devices. Liquid cooling adds significant costs and reliability concerns to system designs, and is thus undesirable in many cases. Methods of improving the heat transfer efficiency of air-cooled heat sinks are needed to extend their use to higher power components.

### SUMMARY

One embodiment is a heat sink comprising a base, fins attached to the base and a flow diverter in contact with the base or at least one of the fins. The flow diverter has a rectangular cross-sectional profile in a plane that is coplanar with and elevated above a plane of the base and spanning the entire separation distance, and, a segment of the flow diverter is angled towards the base to direct the fluid flow towards the base.

Another embodiment is a method that comprises providing a heat sink having a base and fins attached thereto. The method also comprises forming flow diverter in contact with the base or at least one of the fins. The method also comprises configuring the flow diverter to have a rectangular cross-sectional profile in a plane that is coplanar with and elevated above a plane of the base and spanning the entire separation distance, and, a segment of the flow diverter angled towards the base to direct the fluid flow towards the base.

### BRIEF DESCRIPTION OF THE DRAWINGS

Various embodiments are understood from the following detailed description, when read with the accompanying figures. Various features may not be drawn to scale and may be arbitrarily increased or reduced in size for clarity of discussion. Various features in figures may be described as “vertical” or “horizontal” for convenience in referring to those features. Such descriptions do not limit the orientation of such features with respect to the natural horizon or gravity. The term “surface” unless otherwise qualified applies to the combined surface of the heat sink, that is, the surface of the base, fins and any projections therefrom. Reference is now made to the following descriptions taken in conjunction with the accompanying drawings, in which:

FIG. 1 illustrates a prior art heat sink;

FIG. 2 illustrates air flow regions between two fins of a heat sink;

FIG. 3A illustrates a perspective view of an embodiment of a heat sink with one configuration of a flow diverter of the disclosure

FIG. 3B presents plan and sectional views of an embodiment of a heat sink similar to the heat sink presented in FIG. 3A;

FIG. 3C presents a sectional view of another embodiment of a heat sink of the disclosure similar to the heat sink presented in FIG. 3A;

FIG. 3D presents a sectional view of another embodiment of a heat sink of the disclosure similar to the heat sink presented in FIG. 3A;

FIG. 4A illustrates a perspective view of another embodiment of a heat sink with another configuration of the flow diverter of the disclosure;

FIG. 4B presents plan and sectional views of another embodiment of a heat sink of the disclosure similar to the heat sink presented in FIG. 4A;

FIG. 5A illustrates a perspective view of another embodiment of a heat sink with another configuration of the flow diverter of the disclosure;

FIG. 5B presents plan and sectional views of another embodiment of a heat sink of the disclosure similar to the heat sink presented in FIG. 5A;

FIG. 5C presents plan and sectional views of another embodiment of a heat sink of the disclosure similar to the heat sink presented in FIG. 5A;

FIG. 6A illustrates a perspective view of an embodiment of a heat sink another configuration of the flow diverter of the disclosure of the disclosure where air flow is diverted vertically with respect to a base;

FIG. 6B presents a sectional view of another embodiment of a heat sink of the disclosure similar to the heat sink presented in FIG. 6A;

FIG. 6C presents a three dimensional form of another embodiment of the heat sink similar to the heat sink presented in FIG. 6A; and

FIG. 7 illustrates a perspective view of an embodiment of a heat sink with another configuration of a flow diverter of the disclosure.

### DETAILED DESCRIPTION

Embodiments described herein reflect the recognition that structural features may be used in heat sinks that decrease thermal resistance between the heat sink and a fluid e.g., air. In some embodiments, these structural features may be used to produce unsteady flow of air, e.g., in selected portions of the heat sink to disturb laminar flow near surfaces of the heat sink. In other embodiments, features are formed that direct cooler, faster moving air from one region of a heat sink to a region having hotter, slower flow to increase the rate of heat transfer from the hotter regions. In some embodiments, three dimensional (3-D) rendering and investment casting may be employed to form such structural features in a cost-effective manner.

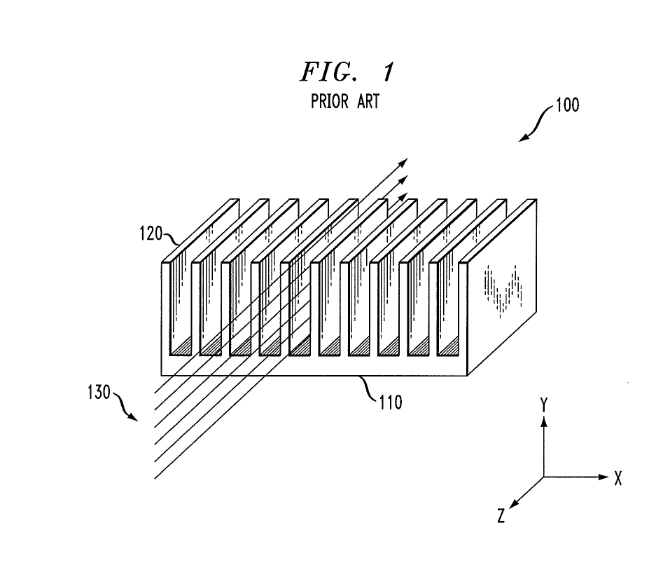

FIG. 1 illustrates a prior art heat sink 100. Features of the heat sink 100 include a base 110 and fins 120. The fins 120 of such heat sinks are typically structurally uniform, e.g., there are no projections or depressions in the surface of the fins 120 other than surface roughness typical of the particular manufacturing method.

An air stream 130 passes between the fins 120 with little obstruction. It is thought that as air enters the space between two fins, a boundary layer forms near the surfaces of the fins 120 and the base 110. The boundary layer is a region of airflow adjacent to a surface that contains a velocity gradient. The gradient arises due to the fact that the velocity at the surface is about zero. Outside the boundary layer, in the so-called “free-stream” region, the velocity gradients are small or negligible. Therefore, the flow must go from nearly zero velocity at the wall to the free-stream velocity away from the wall within the boundary layer. The boundary layer acts as a thermal insulator. Thus, in general, the thinner the boundary layer, the lower the thermal resistance between the flowing air and a heat sink element such as a fin 120.

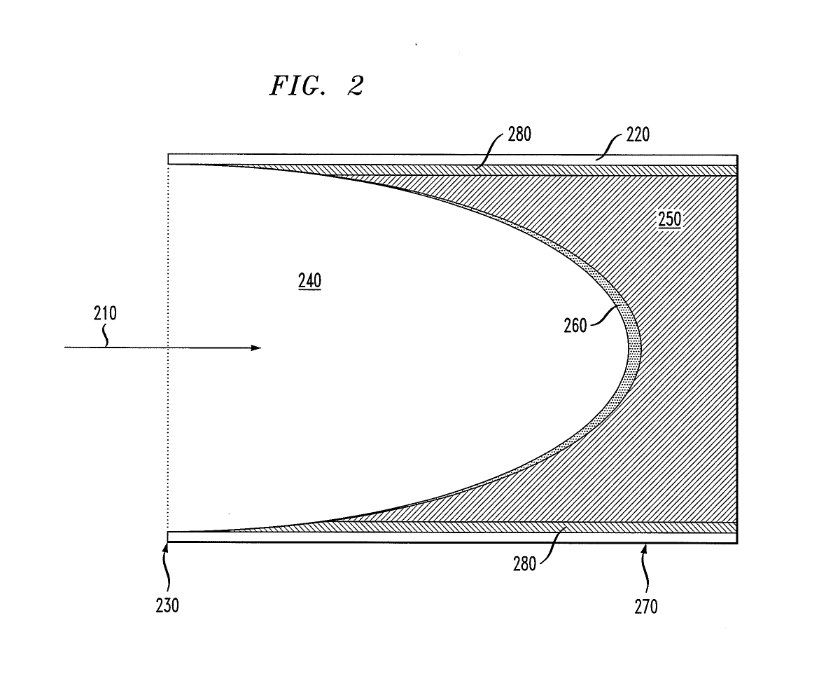

FIG. 2 illustrates a schematic view of a nonlimiting model of a fluid 210 flowing between two conventional fins 220 with an opening 230 between them. By convention, the direction of flow of the air stream 210 is downstream, and the opposite direction is upstream. Within a region 240, the air stream 210 flows with free-stream characteristics. Within a region 250 the air stream 210 flows with boundary layer characteristics. A transition region 260 marks a transition from free-stream characteristics to boundary layer characteristics. The boundary layers begin at the opening 230. The thickness of the boundary layer region 250 increases with increasing distance from the opening 230 to a point 270. The boundary layer generally includes a laminar flow region 280 adjacent to the surface of the fin 220 that includes a region of flow parallel to the surface. The laminar flow region may include regions of non-ideal flow, e.g., not exactly parallel to the adjacent surface. Such minor departures from ideal laminar flow are considered laminar flow in the present discussion. The laminar flow region 280 and may include a region of non-parallel flow. At the point 270, the boundary layer region 250 is fully developed, meaning that essentially all of the air flows in a region of smoothly decreasing velocity gradient with increasing distance from the fins 220. It is thought that the resistance of heat transfer between the air stream 210 and the fins 220 decreases with increasing boundary layer thickness, and more particularly with increasing thickness of the laminar flow region 280. At the point 270, the heat transfer rate is thought to reach a minimum. Thus, the thermal resistance is expected to increase from the opening 230 to a maximum at about the point 270.

Embodiments described herein reflect the recognition that a laminar flow region adjacent a heat sink surface, e.g., a surface of a fin or a base, may be disturbed using structural elements, referred to herein as flow diverters. “Disturbed” as applied to a laminar flow region means that the laminar flow region has flow characteristics it would not have in the absence of the flow diverter. Examples of disturbed laminar flow region include, e.g., thinning, flow separation, and flow non-parallel to the adjacent surface.

Without limitation by theory, the flow diverters are thought to produce vortexes or unsteady flow at the downstream side of the flow diverters. Unsteady flow may include, e.g., vortices and eddies, and transitional, turbulent, unstable, chaotic and resonant airflow. In some cases, a low pressure region is thought to form on the downstream side of a flow diverter. The low-pressure region is thought to cause the fluid to flow in a manner that impinges on the laminar flow region adjacent the surface, e.g., the laminar flow region 280. Such diversion of, e.g., a fluid stream causes diverts the fluid from a greater distance above the surface to a lesser distance above the surface. Because the thermal resistance of the heat sink is in part a function of the thickness of the laminar flow region, the impinging may have the effect of increasing the rate of heat transfer between the fluid and the heat sink. The flow diverters may be configured to reduce thermal resistance of a portion of a heat sink or the entire heat sink. For example, it may be desirable to reduce thermal resistance of only a portion of a heat sink located proximate a region of an electronic device that generates more heat than other regions of the device.

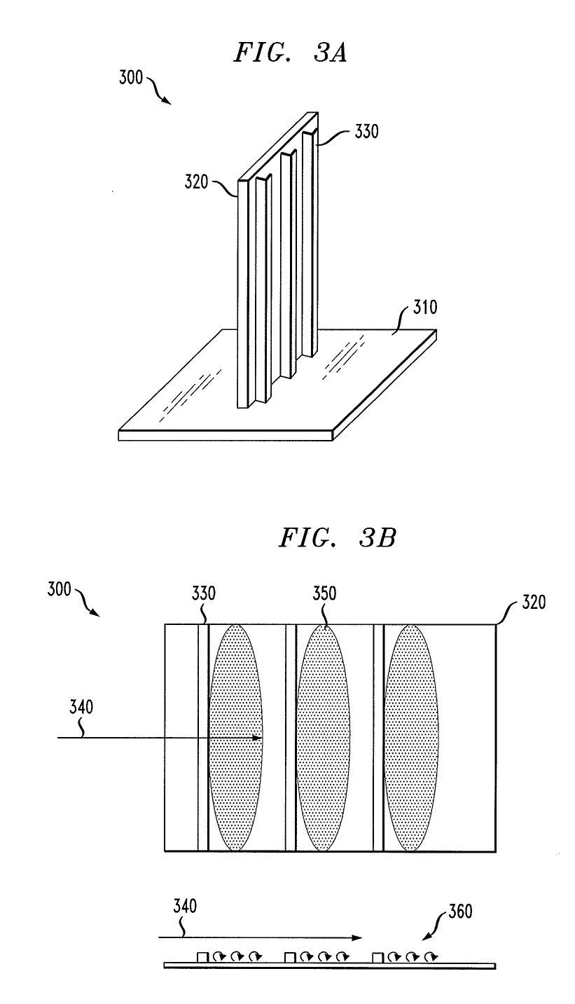

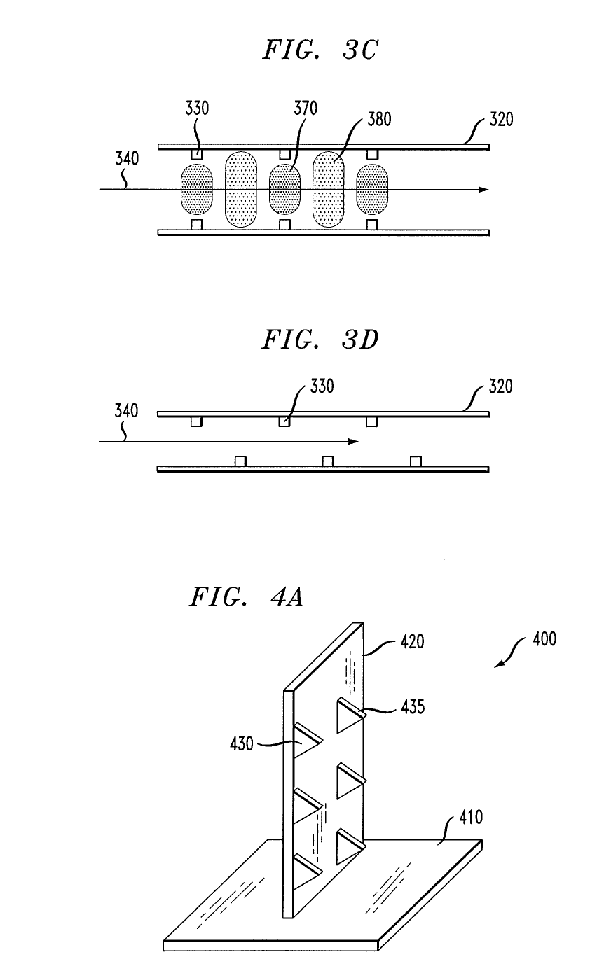

FIG. 3A illustrates one embodiment of a heat sink 300 having a base 310 and a fin 320 formed thereon. Flow diverters 330 are attached to the fin 320. FIG. 3B illustrates the fin 320 in plan view and sectional view. An fluid stream 340 flows past the flow diverters 330. The fluid stream 340 may a gas or a liquid, and may be used to transfer heat to or from a heat sink, depending on the application. For simplicity of discussion a fluid stream is referred to herein after as an air stream, while recognizing that other gases or liquids may be used as a heat exchange medium. Furthermore, heat is referred to as being extracted from the heat sink, while recognizing heat could be extracted by the heat sink from the fluid stream.

In this embodiment of FIG. 3A, the flow diverters 330 are square cylindrical elements having a length equal to or less than the height of the fin 320 above the base 310. The flow diverters 330 may have any desired cross-sectional profile, e.g., circular, square or triangular. Any shape that has the effect of causing a portion of the air stream 340 to impinge on a laminar flow region proximate the surface of the base 310 or the fin 320 is within the scope of this discussion. The flow diverters 330 are also stationary with respect to the fin 320. In other embodiments, the flow diverters 330 may be an active element as described in U.S. patent application Ser. No. 12/165,063, incorporated herein in its entirety. There may be one or a plurality of flow diverters 330 on a fin 320, and a particular heat sink may have flow diverters 330 formed on one or a plurality of fins 320. Flow diverters 330 may be spaced at regular or uneven intervals on the fin 320, and when present on adjacent fins and projecting into the same inter-fin space, may be aligned as illustrated in FIG. 3C or staggered as illustrated in FIG. 3D.

The flow regime of air or other cooling fluid through a heat sink may be characterized by a Reynolds number associated with the heat sink and the flowing fluid. As known by those skilled in the pertinent art, a Reynolds number describes the relationship between inertial forces and viscous forces in a fluid system. Laminar flow occurs when a fluid flows in parallel layers with little or no disruption between the layers. This flow regime is associated with a low Reynolds number. Turbulent flow is characterized by random eddies, vortices and other flow fluctuations, and is associated with a high Reynolds number. A transition regime between laminar and turbulent flow may be characterized by more predictable but non-uniform flow, such as vortices and eddies that are fairly stable over time. Thus, providing a heat sink with flow diverters may be viewed as increasing the Reynolds numbers associated with flow of the cooling fluid through the heat sink.

Turbulent flow is generally associated with greater resistance to flow of fluid. In the context of heat sinks, greater flow resistance translates to a greater pressure drop across the heat sink. In some cases, a greater pressure drop is undesirable. In such cases, the flow diverters 330 may be configured to produce non-uniform flow, but not turbulent flow. In general, such a configuration must be determined experimentally for a combination of cooling fluid, velocity of the fluid, and the configuration of the heat sink.

FIG. 3B illustrates unsteady flow of an air stream 340 over the flow diverters 330. The flow diverters 330 are thought to form a low-pressure region 350 downstream of the flow diverters 330 due to, e.g., flow separation. The low pressure region 350 may produce a standing wave or vortexes 360 at the downstream side of the flow diverters 330 depending on, e.g., the Reynolds number associated with the geometry of the heat sink 300 and the velocity of the air stream 340. The standing wave or vortexes 360 include a flow direction component normal the surface of the fin 320. This normal flow may have the effect of compressing the laminar flow region proximate the surface of the fin 320, thus reducing the thermal resistance between the fin 320 and the air stream 340.

FIG. 3C illustrates an embodiment in which the flow diverters 330 are configured to cause air flow through the heat sink 300 to be resonant. In this nonlimiting example, the flow diverters 330 cause a standing pressure wave resulting in regions of differing pressure, e.g., low pressure regions 370 and high pressure regions 380. The formation of the standing wave is expected to occur at a range of velocity of the air stream 340 that is dependent on the geometry of the fins 320 and the flow diverters 330. The flow diverters 330 may be configured to form the low pressure regions 370 and the high pressure regions 380 at positions that result in reduction of the thermal resistance between the fins 320 and the air stream 340 near a portion of the heat sink 300 at which lower thermal resistance between the heat sink 300 and the air stream 340 is desired.

FIG. 3D illustrates an embodiment in which the flow diverters 330 are placed on opposing faces of fins 320 in a staggered configuration. In some cases, it is thought that staggering the flow diverters 330 may aid the formation of a desired air flow characteristic, e.g., unsteady or resonant air flow, at a particular flow velocity of the air stream 340. Configurations of the flow diverters 330 may be combined in any desired manner within a heat sink to result in the desired flow characteristics. A configuration may be determined, e.g., by wind-tunnel analysis or numerical modeling.

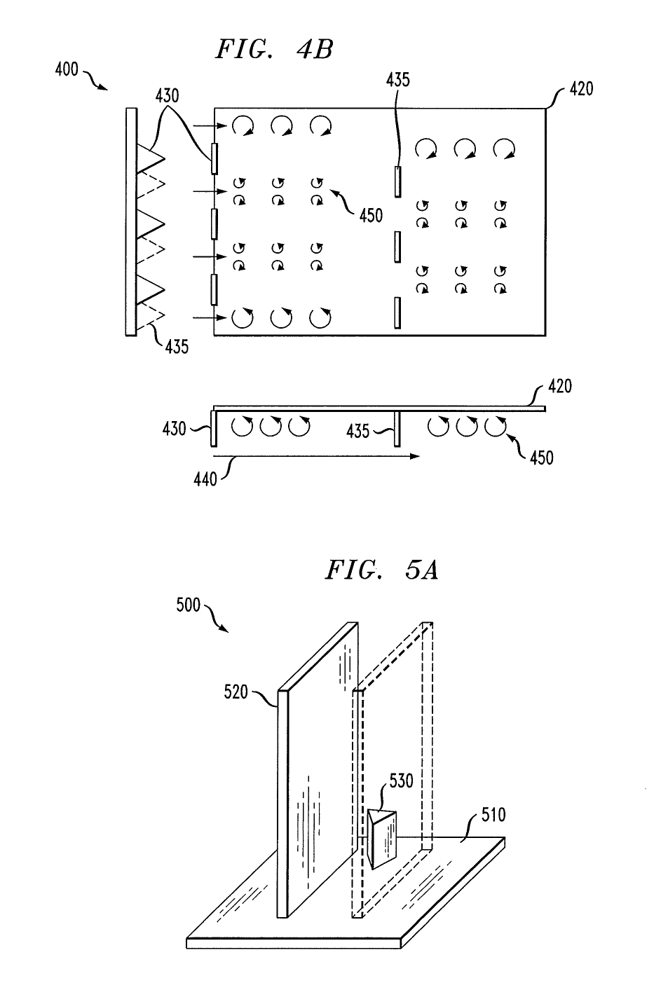

Turning to FIG. 4A, illustrated is an embodiment of a heat sink 400 including a base 410 and a fin 420 thereon. A number of flow diverters 430 are placed at the leading edge of the fin 420. These flow diverters 430 present a 2-D profile to an air stream (in the plane of the fin 420), in contrast to the flow diverters 330, which present a 1-D profile. In some cases, the length of the flow diverters 430 in the plane of the fin 420 is less than about the height of the fin 420. Thus, multiple flow diverters 430 may be placed in a line with space between them, as illustrated in FIG. 4A. In some cases, flow diverters 435 may be placed on the fin 420 downstream of the leading edge of the fin 420 instead of or in addition to the flow diverters 430.

FIG. 4B illustrates the fin 420 in plan view and sectional view. An air stream 440 flows past the flow diverters 430. The flow diverters 430 cause unsteady flow on the downstream side, illustrated without limitation as vortexes 450. In this case, the vortexes 450 have a more complex motion due to the fact that the flow diverters 430 present a two-dimensional cross-section to the air stream 440. The vortexes 450 are thought to have a direction component parallel and a direction component normal to the surface of the fin 420. It is believed that in some flow regimes this motion is particularly effective at reducing thermal resistance between the fin 420 and the air stream 440.

As mentioned above, flow diverters 435 may be placed downstream of the leading edge of the fin 420 in addition to the flow diverters 430. These downstream flow diverters 435 may be aligned with upstream flow diverters 430 or they may be staggered, as illustrated, causing air to take a more tortuous path between the fins 430.

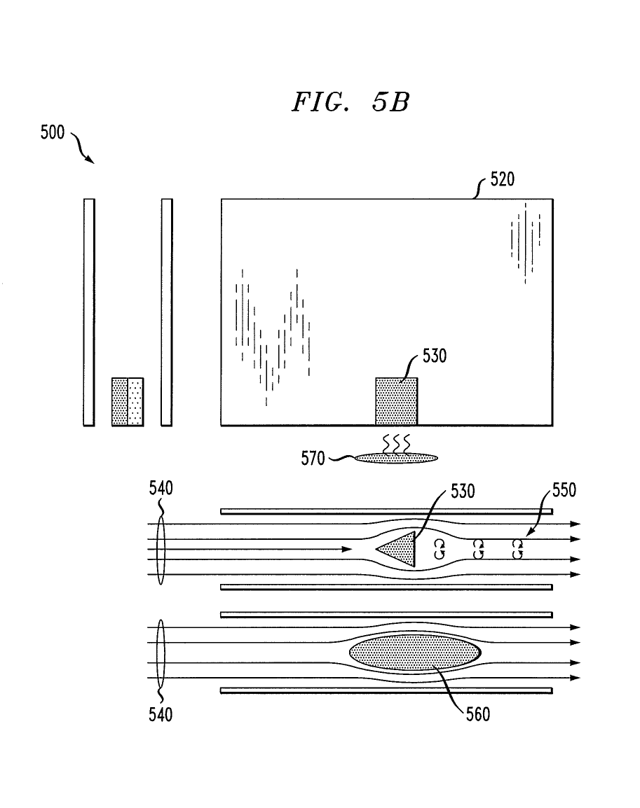

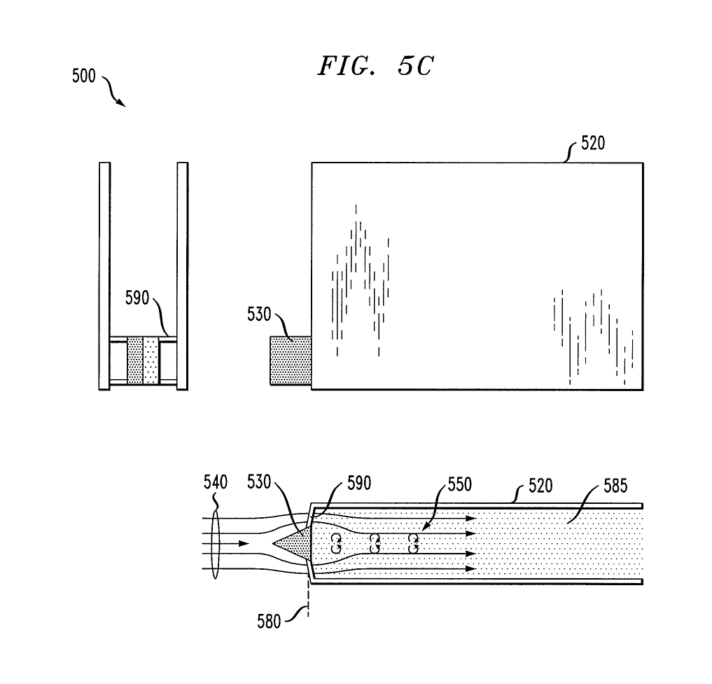

Turning to FIG. 5A, illustrated is a heat sink 500 having a base 510 and two fins 520. A flow diverter 530 is attached to the base 510 between the fins 520. The flow diverter 530 has, e.g., a triangular cross section in the plane of the base, but could have any other desired cross section, such as circular, elliptical, square, or a more complex cross section. The flow diverter 530 may have any height above the base 510, though typically the height will be less than or equal to the height of the fin 520. One flow diverter 530 is illustrated, but other embodiments include multiple flow diverters 530 between the fins 520. Multiple flow diverters 530 may be the same or different heights, or have the same or different cross sectional profiles.

FIG. 5B illustrates plan and sectional views of the fins 520. The embodiment 500 has a single triangular flow diverter 530 with an air stream 540 impinging thereon. Air is forced to flow between the flow diverter 530 and the fin 520, thereby increasing its velocity. The greater air speed parallel to the fin 520 is thought to cause the laminar flow region proximate the fin 520 to thin, thus reducing the thermal resistance between the air stream 540 and the fin 520.

When a flow diverter 530 has an abrupt transition downstream of the leading edge, such as for the illustrated triangular flow diverter 530, vortexes 550 may be formed. In some cases, such vortexes may be undesirable, such as when induced drag associated with the vortexes 550 increases the pressure drop across the heat sink.

An alternate embodiment is illustrated in FIG. 5B in which a flow diverter 560 has an elliptical or streamlined cross section. In one embodiment, the flow diverter is configured as an elliptical airfoil. In each of these embodiments, the air stream 540 is forced to flow faster between the flow diverter and the fins 520 as before. However, the streamlined profile of the flow diverter 560 reduces the formation of vortexes at the downstream side, resulting in lower drag. This lower drag is expected to reduce the pressure drop across the heat sink 500, improving heat transfer relative to the heat sink 500 using the triangular flow diverter 530.

FIG. 5C illustrates an embodiment in which the flow diverter 530 is positioned at a location 580 upstream of the fins 520 and outside a volume 585 bounded by the fins 520. The volume 585 is that volume between the fins 520 that does not extend beyond the terminus of the fins 520. The flow diverter 530 is attached to the fins 520 by, e.g., supports 590. The flow diverter 530 may be any shape and may be placed in any position relative to the fins 520 that disturbs laminar flow of the air stream 540 adjacent to the fins 520. In another embodiment, not shown, the flow diverter 530 is attached to a portion of the base, e.g., the base 510, that extends beyond the terminus of the fins 520.

In each of the embodiments illustrated in FIG. 3, FIG. 4, and FIG. 5, the flow diverters may optionally be placed at a position downstream of the leading edge of the fin (e.g., fin 320, 420, 520) to reduce thermal resistance between the fin and the air stream in the vicinity of a hot spot. A hot spot is a region of relatively greater heat flux from an integrated circuit, e.g., relative to the surrounding areas of the circuit. By so placing the flow diverter, thermal resistance may be reduced in a portion of the heat sink where the lower resistance is particularly beneficial, while minimizing the number of flow diverters to reduce resulting pressure drop.

Returning briefly to FIG. 5B, an embodiment is illustrated in which the flow diverter 530 is placed over a hot spot 570. It is expected that the heat flux from the hot spot 570 will be partially localized to the portion of the fins 520 immediately above the hot spot 570. Therefore, reducing the thermal resistance between the fins 520 and the air stream 540 by decreasing the thickness of the laminar flow region in the vicinity of the hot spot 570 is expected to be particularly beneficial.

In some cases, the flow diverter (e.g., flow diverter 330, 430 or 530) may be placed near the point where the boundary layers between fins become fully developed. Referring to FIG. 2, this point would be, e.g., about at the point 270. Placement of the flow diverter near this point is thought to be particularly beneficial in some cases in that the number of flow diverters in an air path may be reduced. The effect of drag caused by the flow diverter may be balanced against the benefit of disrupting laminar flow regions by only placing the flow diverters at points of convergence of the boundary layers. Depending on factors such as fin spacing and the length of the path between the fins, two or more points of boundary layer convergence may possible in the path of air flow between the fins. In an embodiment, a flow diverter is placed at each convergence point in an air path.

In each of the illustrated embodiments, the flow diverters may or may not be integral to the structure of the heat sink. When a flow diverter is not integral, it may be, e.g., a metal or plastic portion affixed to the remaining portion of the heat sink. The flow diverter may be affixed by adhesive, welding, or brazing, e.g., or in some cases may simply be held in place by friction. In some cases, it may be desirable to use a heat transfer agent such as thermal grease to increase thermal coupling between the flow diverter and the remaining portion of the heat sink.

When the flow diverter is integral to the heat sink, the heat sink and the flow diverter may be formed as a monolithic structure, e.g., by the method of three dimensional (3-D) printing and investment casting. Such a method is disclosed in U.S. patent application Ser. No. 12/165,225, incorporated herein in it entirety. Briefly described, the method provides for using a 3-D printer to produce a sacrificial form of a heat sink. The form is used to fashion a mold, and is then melted or vaporized out of the mold. The mold is then used to form the final heat sink. This method provides the ability to form detailed 3-D patterns that might not be manufacturable by conventional methods, such as machining, die casting, folding or skiving. Moreover, the structural features are extensions of a single physical entity, e.g., a polycrystalline metallic casting. In addition to forming structural details not amendable to other methods, a monolithic structure is expected to reduce thermal resistance within the heat sink, making a greater surface area available to transfer heat to the air stream.

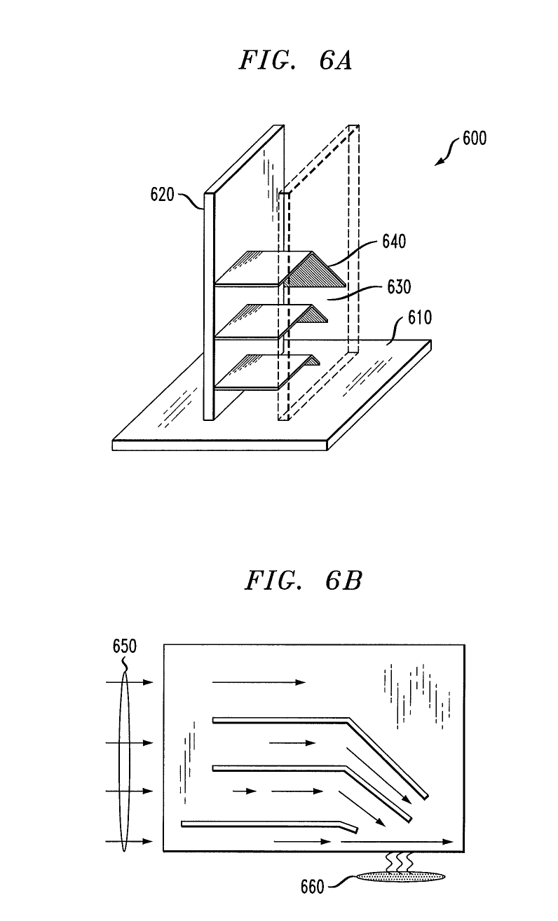

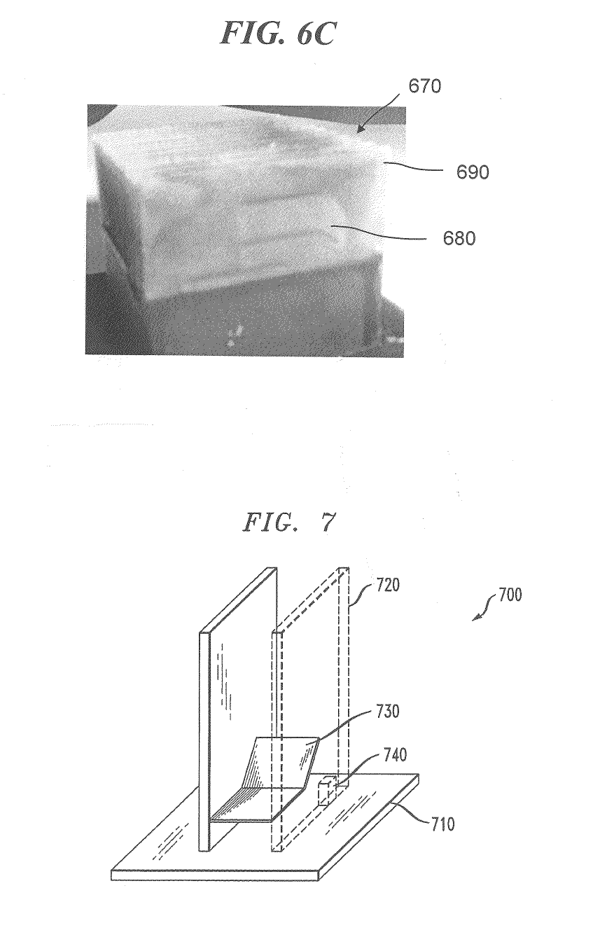

Turning to FIG. 6A, illustrated is an embodiment of a ducted heat sink 600 in a projection view. The heat sink 600 includes a base 610 and fins 620 thereon. Air flow is diverted by one or more ducts 630 between the fins 620. The ducts 630 may be formed by planar segments 640, as illustrated, or any other desired shape, such as smoothly curved surfaces.

As illustrated in FIG. 6B, in side view, the ducts 630 divert an air stream 650 from a direction generally parallel to the base 610 to a direction having a component normal to the base 610. Thus, cooler, faster air from a portion of the heat sink 600 further from the base 610 may be diverted to a region of warmer, slower air nearer to the base 610 at a hot spot 660. Moreover, because the air diverted by the one or more ducts 630 joins the flow of air near the base 610, a greater volume of air per unit time may be caused to flow over the hot spot 660 than may otherwise occur absent the ducts 630.

FIG. 6C illustrates a sacrificial form 670 of the heat sink 600 formed by 3-D printing. Ducts 680 may be seen through the semi-transparent fins 690 of the form 670. As described previously, the form 670 may be used to render the heat sink 600 in, e.g., a metal to produce a monolithic heat sink with the ducts 680 in a practical and efficient manner.

FIG. 7 illustrates an embodiment of a heat sink 700 having a base 710 and fins 720 thereon. A flow diverter 730 directs air flow from a lower level of the heat sink 700 to a higher level. The fin 720 also includes an optional opening 740 formed therein. The flow diverter 730 and the opening 740 may be positioned to allow cooler air from one portion of the heat sink 700 to flow through the fin 720 due to a pressure differential formed on the downstream side of the flow diverter 730. The cooler air can then displace or mix with warmer air in the vicinity of a hot spot, e.g., thereby increasing the rate of heat removal from the hot spot. Optionally, another flow diverter may be positioned on the side of the fin 720 opposite the flow diverter 730 to direct air into the opening 740. Without limitation, the investment casting method described above is well-suited to economically forming such features at the scale of heat sinks used to cool electronic components.

The various embodiments described herein may be combined in any desired manner to result in a desired air flow characteristic from a heat sink. Moreover, while the embodiments are described with respect to parallel-fin heat sinks, the embodiments may be practiced with heat sinks of other geometries where thermal resistance may be reduced by disturbing laminar flow regimes near a surface of the heat sink. Although the present invention has been described in detail, those skilled in the art should understand that they can make various changes, substitutions and alterations herein without departing from the spirit and scope of the invention in its broadest form.

What is claimed is:

1. A heat sink comprising:
a base;
fins attached to said base; and
a flow diverter in contact with said base or at least one of said fins, wherein said flow diverter has a rectangular cross-sectional profile in a plane that is coplanar with and elevated above a plane of said base and spanning said entire separation distance, and, a segment of said flow diverter is angled towards said base to direct said fluid flow towards said base.

2. The heat sink as recited in claim 1, wherein said flow diverter is in contact with said fins and not in contact with said base.

3. The heat sink as recited in claim 1, wherein a height of said flow diverter is less than a height of said fins.

4. The heat sink as recited in claim 1, wherein said fins and flow diverters are configured to allow said fluid to flow between said fins about parallel to said base.

5. The heat sink as recited in claim 1, further including a second flow diverter having said rectangular cross-sectional profile that is coplanar with a plane of said base and spanning said entire separation distance and located in-between said base and said flow diverter, wherein said second flow diverter is located closer to said base than said flow diverter and a segment of said second flow diverter is more shallowly angled towards said base than said segment of said flow diverter.

6. The heat sink as recited in claim 5, wherein said flow diverter and said second flow diverter form a duct between said two adjacent fins and said duct diverts said fluid flow from a direction parallel to said base to a direction having a component normal to said base.

7. The heat sink as recited in claim 5, further including a third flow diverter having said rectangular cross-sectional profile that is coplanar with a plane of said base and spanning said entire separation distance and located in-between said base and said flow diverter, wherein said third flow diverter is located closer to said base than said second flow diverter and a segment of said third flow diverter is more shallowly angled towards said base than said segment of said second flow diverter.

8. The heat sink as recited in claim 7, wherein said second flow diverter and said third flow diverter form a second duct between said two adjacent fins and said second duct diverts said fluid flow from a direction parallel to said base to a direction having a component normal to said base.

9. The heat sink as recited in claim 1, wherein said directed fluid flow has an increased velocity towards said base as compared to an average fluid flow velocity between said adjacent pairs of fins.

10. The heat sink as recited in claim 1, wherein said heat sink is in thermal contact with a device configured to dissipate heat, and said flow diverter is configured to direct said fluid from a region of relatively lower power dissipation by said device to a region of relatively greater power dissipation by said device.

11. A method, comprising:
providing a heat sink having a base and fins attached thereto;
forming flow diverter in contact with said base or at least one of said fins; and
configuring said flow diverter to have a rectangular cross-sectional profile in a plane that is coplanar with and elevated above a plane of said base and spanning said entire separation distance, and, a segment of said flow diverter angled towards said base to direct said fluid flow towards said base.

12. The method as recited in claim 11, wherein said flow diverter is formed in contact with said fins and not in contact with said base.

13. The method as recited in claim 11, wherein said flow diverter has a height less than a height of said fins.

14. The method as recited in claim 11, wherein said fins and flow diverters are configured to allow said fluid to flow between said fins about parallel to said base.

15. The method as recited in claim 11, further including forming a second flow diverter having said rectangular cross-sectional profile that is coplanar with a plane of said base and spanning said entire separation distance and located in-between said base and said flow diverter, wherein said second flow diverter is located closer to said base than said flow diverter and a segment of said second flow diverter is more shallowly angled towards said base than said segment of said flow diverter.

16. The method as recited in claim 15, wherein said second flow diverter and said third flow diverter form a second duct between said two adjacent fins and said second duct diverts said fluid flow from a direction parallel to said base to a direction having a component normal to said base.

17. The method as recited in claim 11, further including forming a third flow diverter having said rectangular cross-sectional profile that is coplanar with a plane of said base and spanning said entire separation distance and located in-between said base and said flow diverter, wherein said third flow diverter is located closer to said base than said second flow diverter and a segment of said third flow diverter is more shallowly angled towards said base than said segment of said second flow diverter.

18. The method as recited in claim 17, wherein said second flow diverter and said third flow diverter form a second duct between said two adjacent fins and said second duct diverts said fluid flow from a direction parallel to said base to a direction having a component normal to said base.

19. The method as recited in claim 18, wherein said directed fluid flow has an increased velocity towards said base as compared to an average fluid flow velocity between said adjacent pairs of fins.

20. The method as recited in claim 11, wherein said heat sink is in thermal contact with a device configured to dissipate heat, and said flow diverter is configured to direct said fluid from a region of relatively lower power dissipation by said device to a region of relatively greater power dissipation by said device.
